(19) United States
(12) Patent Application Publication
(10) Pub. No.: US 2020/0151695 A1
(43) Pub. Date: May 14, 2020

(54) POINT-OF-SALE DATA PROCESSING APPARATUS THAT PROCESSES DATA USING MULTIPLE USER CODES

(71) Applicant: TOSHIBA TEC KABUSHIKI KAISHA, Tokyo (JP)

(72) Inventors: Koichi SUGIYAMA, Izunokuni Shizuoka (JP); Yasuhiro ARAI, Mishima Shizuoka (JP)

(21) Appl. No.: 16/742,146

(22) Filed: Jan. 14, 2020

Related U.S. Application Data
(63) Continuation of application No. 14/788,917, filed on Jul. 1, 2015.

(30) Foreign Application Priority Data
Jul. 17, 2014 (JP) 2014-147155

(51) Int. Cl. G06Q 20/20; G06Q 30/02; G06Q 20/32; G06Q 20/04; G06Q 30/06

(52) U.S. Cl. CPC G06Q 20/204; G06Q 30/0268; G06Q 20/209; G06Q 20/322; G06Q 30/0238; G06Q 20/20; G06Q 20/202; G06Q 30/06; G06Q 20/0453

(57) ABSTRACT

A point-of-sale data processing apparatus includes a user code reading unit configured to read at least one of first and second codes associated with a user, a product code reading unit configured to read product codes, a communication unit, and a control unit. The control unit is configured to determine the first code if the second code is read using the user code reading unit and the second code if the first code is read using the user code reading unit, compile first and second data using the product codes read using the product code reading unit, and control the communication unit to transmit the first data and the first code to a first server that stores the first data in association with the first code, and the second data and the second code to a second server that stores the second data in association with the second code.

### CROSS-REFERENCE TO RELATED APPLICATIONS

This application is a continuation of U.S. patent application Ser. No. 14/788,917, filed on Jul. 1, 2015, which is based upon and claims the benefit of priority from Japanese Patent Application No. 2014-147155, filed on Jul. 17, 2014, the entire contents of each of which are incorporated herein by reference.

### FIELD

Embodiments described herein relate generally to a point-of-sale (POS) data processing apparatus, in particular a POS data processing apparatus that processes data based on multiple user codes.

### BACKGROUND

An electronic receipt system of one type transmits electronic data (i.e., an electronic receipt) of a purchase transaction at a store to a computing device of a customer, such as a mobile device, instead of issuing a conventional paper receipt that is handed to the customer upon completion of the purchase transaction. Each customer who participates in the electronic receipt system has an assigned customer code that can be used at stores that participate in the electronic receipt system, and the customer typically needs to present his or her customer code at the stores, in order to receive the electronic receipts.

Meanwhile, each of the stores that participate in the electronic receipt system may provide a reward, such as reward points, to promote sales at the store. To manage the rewards provided to customers, each of the stores assigns a unique reward user code to each customer, and each customer typically needs to present his or her reward user code at a store to receive a reward from the store.

It would be desirable if the customers can receive both electronic receipts and rewards in a convenient manner.

### DESCRIPTION OF THE DRAWINGS

FIG. 1 illustrates an entire configuration of an electronic receipt system according to an embodiment.

FIG. 2 illustrates an example of a screen after membership registration is completed.

FIG. 3 is a block diagram of a Point-of-sale (POS) terminal in the electronic receipt system.

FIG. 4 is a block diagram of a store server in the electronic receipt system.

FIG. 5 is a block diagram of a headquarter server in the electronic receipt system.

FIG. 6 illustrates a data structure a point master stored in the headquarter server.

FIG. 7 is a block diagram of an electronic receipt management server in the electronic receipt system.

FIG. 8 illustrates a data structure of an electronic receipt management region stored in a storage unit of the electronic receipt management server.

FIG. 9 is a block diagram of a portable terminal in the electronic receipt system.

FIG. 10 illustrates an example of receipt data.

FIG. 11 illustrates an example of an electronic receipt.

FIG. 12 is a block diagram of functional sections generated in a control unit of the POS terminal.

FIG. 13 is a flowchart illustrating a flow of control processing carried out by the POS terminal.

FIG. 14 is a flowchart illustrating a flow of association processing carried out by the POS terminal.

FIG. 15 is a flowchart illustrating a flow of member ID inquiry processing carried out by the POS terminal.

FIG. 16 is a flowchart illustrating a flow of PTID inquiry processing carried out by the POS terminal.

FIG. 17 is a flowchart illustrating a flow of settlement processing carried out by the POS terminal.

FIG. 18 is a flowchart illustrating a flow of card selection processing carried out by the POS terminal.

FIG. 19 is a flowchart illustrating a flow of control processing carried out by the store server.

FIG. 20 is a flowchart illustrating a flow of electronic receipt management processing and information transmission processing carried out by the headquarter server.

FIG. 21 is a block diagram of functional section generated in a control unit of the electronic receipt management server.

FIG. 22 is a flowchart illustrating a flow of management processing of electronic receipt information carried out by the electronic receipt management server.

FIG. 23 is a flowchart illustrating a flow of electronic receipt reception processing and electronic receipt displaying processing carried out by the portable terminal.

### DETAILED DESCRIPTION

According to one embodiment, a point-of-sale data processing apparatus includes a user code reading unit configured to read at least one of first and second codes associated with a user, a product code reading unit configured to read product codes, a communication unit, and a control unit. The control unit is configured to determine the first code if the second code is read using the user code reading unit and the second code if the first code is read using the user code reading unit, compile first and second data using the product codes read using the product code reading unit, and control the communication unit to transmit the first data and the first code to a first server that stores the first data in association with the first code, and the second data and the second code to a second server that stores the second data in association with the second code.

According to another embodiment, a method for processing data related to purchase of products by a user, includes reading a user code of the user, reading product codes of the products, determining a first code if the read user code is a second code and the second code if the read user code is the first code, compiling first and second data using the read product codes, and transmitting the first data and the first code to a first server that stores the first data in association with the first code and the second data and the second code to a second server that stores the second data in association with the second code.

According to another embodiment, a system for processing data related to purchase of products by a user, includes a point-of-sale terminal configured to read at least one of first and second codes associated with the user and product codes of the products, determine the first code if the second code is read and the second code if the first code is read, and compile first and second data using the product codes, a first server configured to receive the first data and the first code from the point-of-sale terminal and store the first data in association with the first code, and a second server configured to receive the second data and the second code from the point-of-sale terminal and store the second data in association with the second code.

Hereinafter, an embodiment will be described with reference to the accompanying drawings.

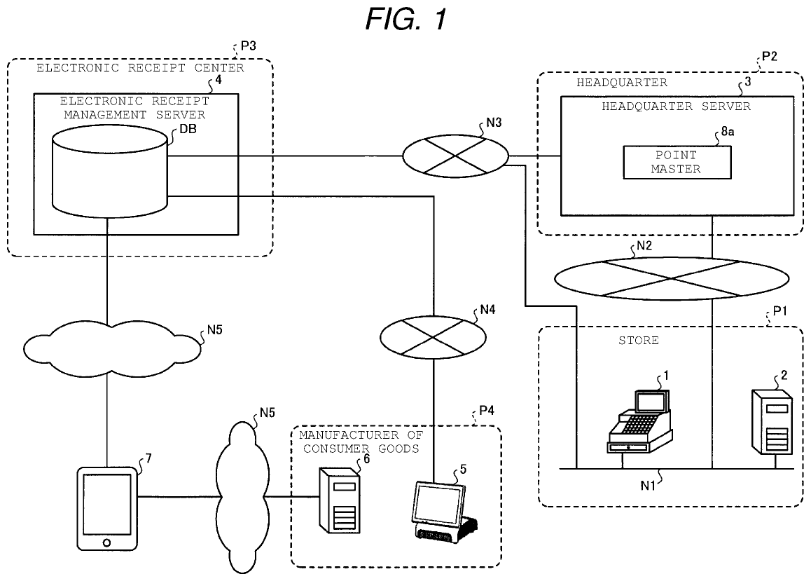

An embodiment will be described with reference to FIGS. 1 to 23. FIG. 1 illustrates an entire structure of an electronic receipt system according to an embodiment. As illustrated in FIG. 1, an electronic receipt system includes a point of sales (POS) terminal 1, which corresponds to a merchandise sales data processing apparatus, a store server 2, which corresponds to a company server, a headquarter server 3, which corresponds to a company server, an electronic receipt management server 4, a promotion setting terminal 5, a promotion management server 6, and a portable terminal 7, which is an example of a customer terminal.

The POS terminal 1 and the store server 2 are provided in a store P1. The POS terminal 1 and the store server 2 are connected through a network N1 in the store P1 such as a local area network (LAN) and configured to communicate with each other. The POS terminal 1 and the store server 2 may be connected to a network N2 which connects the store P1 and a headquarter P2, through a network device (not illustrated) such as a router, which is connected to the network N1 in the store P1. The network N2 may be, for example, a dedicated line such as the Internet and a virtual private network (VPN).

The POS terminal 1 is a merchandise sales data processing apparatus and executes merchandise sales data processing. The POS terminal 1 generates receipt data which includes transaction details, causes a printing unit 13 to print the generated receipt data, as a paper receipt. The POS terminal 1 outputs (transmits) electronic receipt information which is obtained by converting a data format of the receipt data, to the electronic receipt management server 4 through a network N3. A transmission method of the electronic receipt information is not particularly limited, and a general protocol such as HTTP and HTTPS may be employed. The network N3 may be, for example, a dedicated line such as the Internet and a virtual private network (VPN).

The store server 2 corresponds to a company server and integrally manages merchandise sales data processing and the like executed by the POS terminal 1. For example, the store server 2 stores and manages merchandise sales data which is generated through the merchandise sales data processing by the POS terminal 1, and the store server 2 stores and manages a merchandise data file used in the merchandise sales data processing.

In the present embodiment, the POS terminal 1 outputs electronic receipt information. However, it is not limited thereto and the electronic receipt information may be generated by the store server 2 or a conversion device (not illustrated) that converts a data format of receipt data generated by the POS terminal 1, and the generated electronic receipt information may output to the electronic receipt management server 4.

The headquarter server 3 corresponds to a company server and is provided in the headquarter P2 of a company which operates one or more stores or chained stores and manages various kinds of information of the company.

The headquarter server 3 receives various kinds of information from the POS terminal 1 through the network N2. The headquarter server 3 has, for example, functions of sales management, sales analysis, inventory management, and the like of the corresponding company.

The headquarter server 3 includes a point master 8a. The point master 8a stores point information of customers, which is generated by the POS terminal 1 in the store P1. The point master 8a stores a point value (numeric value) which is currently redeemable by the corresponding customer with respect to each PTID.

The electronic receipt management server 4 is provided in an electronic receipt center P3. The electronic receipt center P3 may be, for example, a third party organization other than the company which operates the headquarter server 3. Alternatively, the third party organization may manage the headquarter server 3.

The electronic receipt management server 4 functions as a receipt management server for customers, which integrally manages electronic receipt information of various companies, each of which operates one or more stores. The electronic receipt management server 4 stores and manages member data in a membership master contained in a database DB. The member data includes name and a member ID of a customer (member) who has completed membership registration, and destination information of electronic receipt information for the customer. The member ID corresponds to a customer code and specifies a destination of the electronic receipt information. A membership management server or the like that is independent of the electronic receipt management server 4 and stores and manages the member data may be provided.

The electronic receipt management server 4 receives electronic receipt information transmitted from the POS terminal 1, through the network N3, and stores and manages the received electronic receipt information in an electronic receipt management region 43a in a database DB. More specifically, the electronic receipt information includes data such as a member ID and transaction details (merchandise sales data), and manages the data in correlation with member data of the corresponding member.

The electronic receipt management server 4 receives additional information such as campaign information relating to specific merchandise campaign, from a promotion setting terminal 5, which is connected to a network N4, and stores and manages the received additional information in an additional information management region 43b in the database DB. More specifically, the additional information is managed in correlation with data which satisfies a predetermined condition among data included in the electronic receipt information stored in the database DB.

With regard to electronic receipt information is stored in the database DB, the electronic receipt management server specifies a destination with reference to destination information which is correlated with a member ID in that electronic receipt information. The destination information refers to a member ID or a password. The electronic receipt management server 4 transmits electronic receipt information stored in the database DB, to a destination for the electronic receipt information through a network N5. When additional information is correlated with the electronic receipt information, the additional information is also transmitted to the destination.

When an electronic receipt inquiry designating a member ID is received from the portable terminal 7, which is connected to the electronic receipt management server 4 through the network N5, the electronic receipt management server 4 extracts electronic receipt information associated with the designated member ID from the database DB, and the customer may view the electronic receipt information using the portable terminal 7 designated as the destination. When the additional information is correlated with the electronic receipt information, the customer may also view the additional information using the portable terminal 7.

The electronic receipt management server 4 stores information (referred to as “SRID” below) for specifying a destination of electronic receipt information. A member ID is included in the SRID. Also, a reward member ID (referred to as “PTID” below) for specifying a point card which is issued by each company in order to provide reward points, is included in the SRID. For this reason, a member ID included in an SRID and a PTID stored in the SRID are associated with each other.

The electronic receipt management server 4 stores a membership master (not illustrated) for storing a member ID and a destination of the electronic receipt information, in association. For this reason, by searching the membership master using the member ID included in an SRID as a search key, a destination of electronic receipt information corresponding to the member can be specified.

The promotion setting terminal 5 and the promotion management server 6 are provided in a manufacturer P4 of consumer goods and the like. The promotion setting terminal 5 corresponds to a terminal apparatus such as a personal computer (PC), and transmits additional information to the electronic receipt management server 4 through the network N4. The network N4 may be a dedicated line such as the Internet and a VPN, for example. A transmission method of the additional information is not particularly limited and a general protocol such as HTTP and HTTPS may be employed.

The portable terminal 7 is a terminal apparatus used by a user (customer) of the electronic receipt system, such as a smart phone, a mobile phone, a personal digital assistant (PDA), and a tablet computer, for example. The portable terminal 7 has an installed application for displaying various kinds of information provided over the network N5, such as a web browser. A terminal apparatus of a PC and the like may be applied instead of the portable terminal 7.

The portable terminal 7 accesses the electronic receipt management server 4 through the network N5, and performs membership registration to the electronic receipt system. The network N5 may be the Internet or various public networks.

The membership registration of a customer in the electronic receipt system is performed through the following procedures, for example. A customer transmits a blank mail from the portable terminal 7 to the electronic receipt management server 4 through the network N5. The electronic receipt management server 4 transmits a Uniform Resource Locator (URL) of a webpage for membership registration to a mail address in the received mail. The customer accesses the webpage for membership registration through the portable terminal 7 using the received URL and causes an input screen to be displayed. The input screen is for inputting necessary information (name, transmission destination information, and the like) for the membership registration. After the customer completes to input the necessary information, the electronic receipt management server 4 performs the membership registration to the membership master. Then, the electronic receipt management server 4 delivers a membership registration completion mail including a member ID and a password to the portable terminal 7. As described above, the membership registration can be carried out.

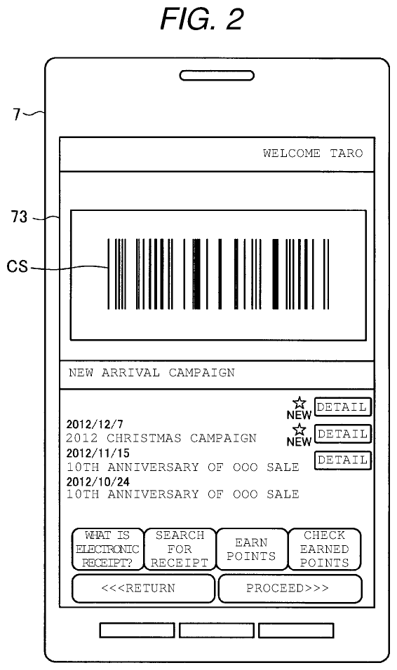

After the above-described membership registration is completed, the portable terminal 7 can display a code symbol CS such as a barcode and a two-dimensional code, which represents a member ID, on a display unit 73 as illustrated in FIG. 2.

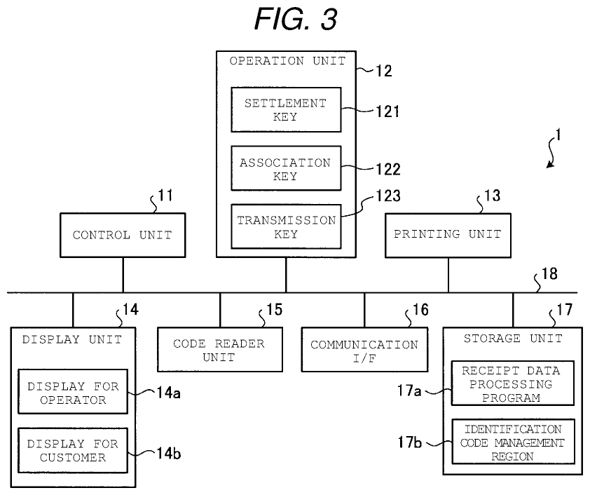

The customer presents the code symbol CS displayed on the portable terminal 7 to a salesperson in the store P1 when a purchase transaction is performed. The salesperson causes a code reader unit 15 (see FIG. 3), which is connected to the POS terminal 1 and includes a scanner, to read the code symbol CS displayed on the portable terminal 7. As a result, a member ID of a customer may be correlated with electronic receipt information, which is generated by the POS terminal 1 after settlement through the merchandise sales data processing.

The customer may view electronic receipt information for a purchase transaction, which is transmitted from the electronic receipt management server 4 through the network N5 after settlement (transaction) in the POS terminal 1, using the portable terminal 7. The portable terminal 7 transmits a member ID to the electronic receipt management server 4 through the network N5. The portable terminal 7 receives electronic receipt information of the corresponding member from the electronic receipt management server 4 and displays the received electronic receipt information on the display unit 73.

In the electronic receipt system having a related configuration, electronic receipt information indicating details of a transaction (settlement), which is generated through the merchandise sales data processing executed by the POS terminal 1 of the store P1 is transmitted from the POS terminal 1 to the electronic receipt management server 4. The transmitted electronic receipt information is uploaded to the web. The portable terminal 7 having an installed web browser, by designating a uniform resource locator (URL), may download the electronic receipt information to the portable terminal 7 and display the downloaded electronic receipt information with the web browser. An application for displaying electronic receipt information may be installed on the portable terminal 7.

Next, configurations of main apparatuses in the electronic receipt system according to the present embodiment will be described.

First, the POS terminal 1, which corresponds to the merchandise sales data processing apparatus, will be described. FIG. 3 is a block diagram of the POS terminal 1. As illustrated in FIG. 3, the POS terminal 1 includes a control unit 11 which generally controls various computations or each unit of the POS terminal 1. The control unit 11 is a computer which includes a central processing unit (CPU), a read only memory (ROM), a random access memory (RAM), a real time clock (RTC) unit, and the like. The ROM stores various programs or data. The RAM stores temporarily various programs or stores various data in a rewritable manner. The RTC unit indicates the current date and time.

The control unit 11 is connected to an operation unit 12, the printing unit 13, a display unit 14, and the code reader unit 15, through a bus 18.

The operation unit 12 has various operation keys in order for an operator to perform input operations. As the operation keys, a numeric key for inputting a numerical value, a cursor key, a selection and determination key for selecting a predetermined item, a subtotal key for instructing an output of a total of merchandise for which sales registration has been performed in a purchase transaction, a settlement key for declaring settlement of a price by executing settlement processing of the purchase transaction, and the like, for example.

The operation unit 12 includes a keyboard in which keys of a settlement key 121, an association key 122, a transmission key 123, and the like are arranged. The settlement key 121 is a key to fix a purchase transaction. The association key 122 is a key to associate a member ID with a PTID. In the present embodiment, the member ID is stored in the portable terminal 7 (customer terminal) of the corresponding customer. The PTID is contained in a point card (membership medium) held by the customer.

The transmission key 123 is a key to transmit the member ID and the PTID to the electronic receipt management server 4.

The printing unit 13 includes a printer device that prints a receipt, a journal, or the like. The printing unit 13 performs printing on a roll sheet using a thermal head having a heating element, for example, and then issues a receipt by cutting off the printed portion of the roll sheet.

The display unit 14 is, for example, a liquid crystal display, or the like, and displays various kinds of information regarding name and price of merchandise registered for sales, a total price, and an amount of change in one transaction for which settlement is declared, and the like. The display unit 14 includes a display 14a for operators, which displays various kinds of information to cashiers, and a display 14b for customers, which displays various kinds of information to customers. The display unit 14 may have a touch panel. In this case, the touch panel functions as the operation unit 12.

The code reader unit 15 is a scanner device for optically reading a code symbol such as a bar code and a two-dimensional code, for example. The code reader unit 15 reads, for example, a code symbol attached to merchandise or a code symbol displayed on the portable terminal 7, and the like. The control unit 11 recognizes information contained in the read code symbol. The code symbol attached to merchandise contains a merchandise code and the like of the merchandise. The code symbol displayed on the portable terminal 7 contains a member ID and the like of the corresponding customer. The member ID may be stored magnetically or electrically in the portable terminal 7. In this case, a dedicated reading apparatus may read the stored member ID. The control unit 11 recognizes the read member ID.

The control unit 11 is connected to a communication I/F (interface) 16 through the bus 18, and configured to be connected to the network N1, the network N2, or the network N3 in the store P1 through the communication I/F 16.

The control unit 11 is also connected to a storage unit 17 through the bus 18. The storage unit 17 is an auxiliary storage device such as a hard disk drive (HDD) and a solid state drive (SSD), for example. The storage unit 17 stores a program for performing various POS operations including the merchandise sales data processing. The storage unit 17 stores various data files relating to the merchandise sales data processing, such as a merchandise data file. The merchandise data file stores merchandise data, such as merchandise name, merchandise code, unit price, and the like of the merchandise. The storage unit 17 also stores a receipt data processing program 17a for performing merchandise sales processing or processing relating to electronic receipt information.

The storage unit 17 also stores a POS number of the own POS terminal 1, a company code (identification code of the corresponding company), a business type and business category code, a store code of the store P1 in which the POS terminal 1 is located, and the like, in an identification code management area 17b. The business type and business category code is, for example, a code (classification code) for identifying a business type and a business category of a store, and, the examples thereof include a convenience store, a supermarket, a department store, a pharmacy, a restaurant, an eating house, and the like. Such a business type and business category may be arbitrarily changed in accordance with preference of a user. The company code and the business type and business category code may be registered in the store server 2 or the headquarter server 3.

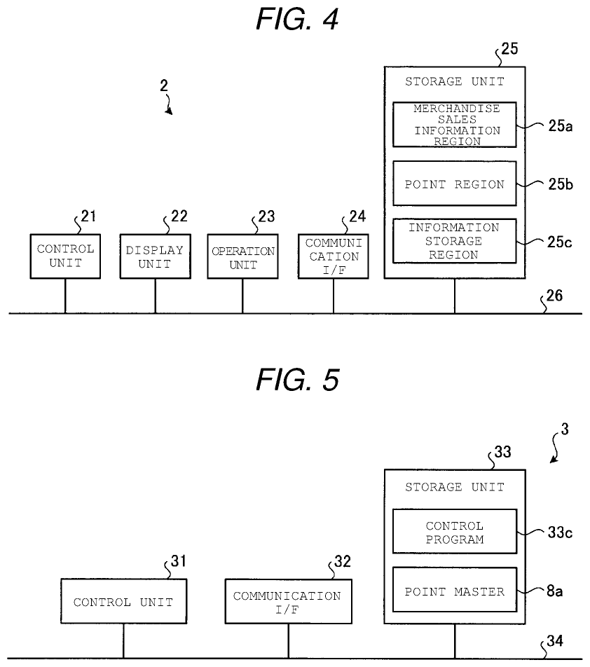

Next, a configuration of the store server 2 will be described with reference to FIG. 4. The store server 2 includes a control unit 21 which generally controls various computations or each unit of the store server 2. The control unit 21 is a computer which includes a CPU, a ROM, a RAM, an RTC unit, and the like. The ROM stores various programs or data. The RAM temporarily stores various programs or stores various data in a rewritable manner. The RTC unit indicates the current date and time.

The control unit 21 is configured to be connected to the network N1 and the network N2 in the store P1 through a communication I/F 24, which is connected to a bus 26. The control unit 21 is also connected to a display unit 22, an operation unit 23, and a storage unit 25 through the bus 26. The display unit 22 displays various kinds of information.

The storage unit 25 includes a merchandise sales information region 25a in which merchandise sales information of the store P1 is stored, a point region 25b in which an SRID including a member ID and a PTID, which are transmitted from the headquarter server 3 and are associated with each other, is stored, and an information storage region 25c in which various kinds of information transmitted from the headquarter server 3 are stored. In the storage unit 25, a control program for controlling the store server 2 is stored. An SRID associated with the company having the headquarter server 3 among SRIDs (that is, the SRID illustrated in FIG. 7) stored in the electronic receipt management region 43a of the electronic receipt management server 4 is transmitted from the headquarter server 3 and stored in the point region 25b.

Next, a hardware configuration of the headquarter server 3, which functions as the server for a company, will be described with reference to a block diagram in FIG. 5. The headquarter server 3 includes a control unit 31 which generally controls various computations or manages points are generated in stores of the company. The control unit 31 is a computer which includes a CPU, a ROM, a RAM, an RTC unit, and the like. The ROM stores various programs or data. The RAM temporarily stores various programs or stores various data in a rewritable manner. The RTC unit indicate the current date and time.

The control unit 31 is connected to a communication I/F 32 through a bus 34 and configured to be connected to the network N2 or the network N3 through the communication I/F 32. The control unit 31 is connected to a storage unit 33 through the bus 34.

The storage unit 33 includes a point master 8a in which a point value which is generated based on settlement information of sold merchandise is stored with respect to each PTID.

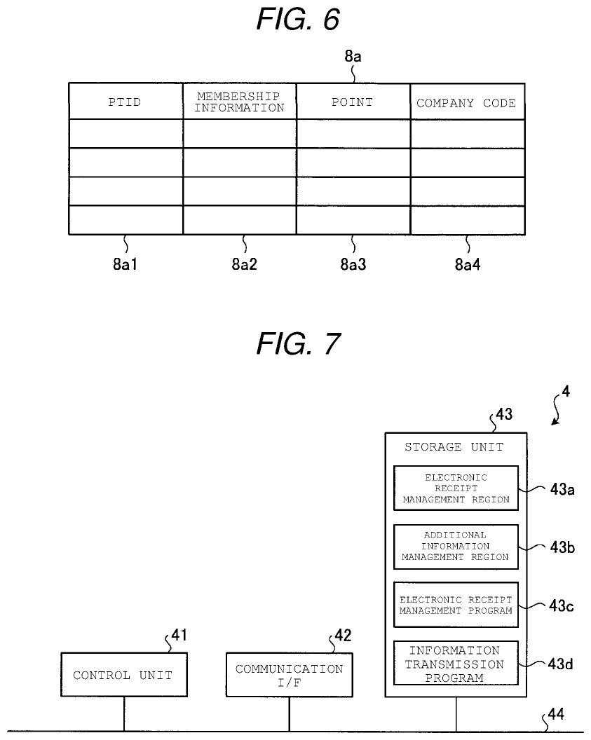

FIG. 6 illustrates a data structure of the point master 8a. In FIG. 6, the point master 8a includes a PTID column 8a1, a membership information column 8a2, a point column 8a3, and a company code column 8a4. In the PTID column 8a1, an ID of a point card held by a member is stored. In the membership information column 8a2, member information (name, address, age, gender, family structure, and the like) of the member is stored. In the point column 8a3, a point value (numeric value) which is currently owned by the customer as a result of using the point card during purchase transactions is stored. In the company code column 8a4, a company code of a company which has issued the point card is stored.

Next, a configuration of the electronic receipt management server 4, which functions as the receipt management server for customers, will be described with reference to a block diagram in FIG. 7. As illustrated in FIG. 7, the electronic receipt management server 4 includes a control unit 41 which generally controls various computations or each unit of the electronic receipt management server 4. The control unit 41 is a computer which includes a CPU, a ROM, a RAM, an RTC unit, and the like. The ROM stores various programs or data. The RAM temporarily stores various programs or stores various data in a rewritable manner. The RTC unit indicates the current date and time.

The control unit 41 is configured to be connected to the network N3, the network N4, and the network N5, through a communication I/F 42 which is connected to a bus 44. The control unit 41 is also connected to a storage unit 43 through the bus 44.

An electronic receipt management region 43a for integrally storing electronic receipt information of various companies which operate stores is included in the storage unit 43, in addition to a membership master management region (not illustrated) for storing and managing a membership master. More specifically, the electronic receipt management region 43a is used to manage the electronic receipt information of the various companies, with respect to each customer.

The electronic receipt information includes a member ID, a company code, a store code, a POS number of the POS terminal 1, a receipt number, merchandise sales data (including merchandise code, and date and time), and the like. A manufacturer P4 of consumer goods, and the like may confirm purchase of merchandise associated with the manufacturer from the electronic receipt information stored in the electronic receipt management server 4, using specific search keys (for example, a specific company which operates a store, a specific district, a specific time, and the like). The manufacturer P4 of consumer goods refers to a manufacturer of a food, a beverage, clothing, cosmetics, a medicine, household goods, and the like.

The storage unit 43 stores various additional information which are correlated with desired merchandise (merchandise code), a member (member ID), a company (company code), and a store (store code) in an additional information management region 43b. The additional information refers to campaign information and the like regarding a promotional campaign and is correlated with particular merchandise and a specific condition (for example, a specific company which operates a store, a specific geographic region, a specific store, a specific time, and the like). The additional information includes, for example, access information such as a URL of a webpage related to the promotional campaign, a URL of a webpage related to a CM of a company, and a URL of a webpage related to a coupon of a company.

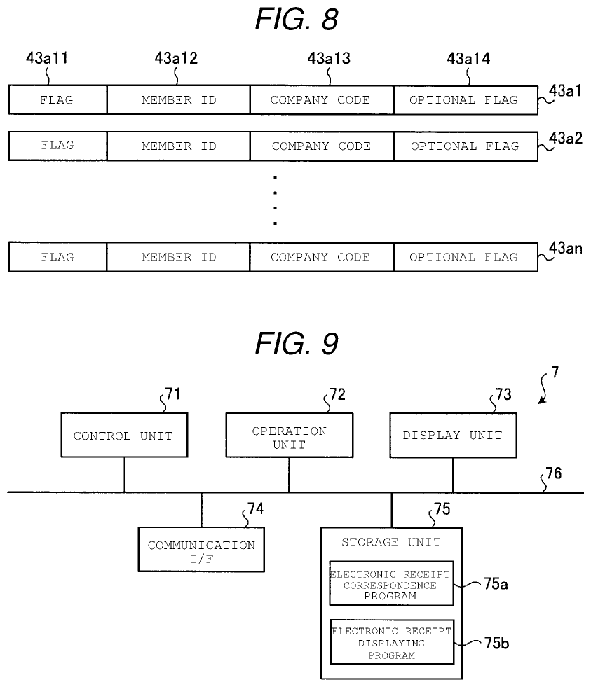

The storage unit 43 stores an electronic receipt management program 43c for managing the electronic receipt information and the additional information of each company in an electronic receipt management region 43a and an additional information management region 43b, in addition to a membership management program (not illustrated) for managing the membership master stored in the membership master region. The electronic receipt management program 43c is executed to transmit an SRID illustrated in FIG. 8 to the headquarter server 3 of each company. The storage unit 43 stores an information transmission program 43d for transmitting the electronic receipt information and the additional information to the portable terminal 7.

Next, the SRID (association information) which is stored in the electronic receipt management region 43a of the electronic receipt management server 4 will be described with reference to FIG. 8.

In FIG. 8, the electronic receipt management region 43a includes a plurality of rows corresponding to SRIDs 43a1 to 43an. For example, the row for the SRID 43a1 includes a flag box 43a11, a member ID box 43a12, a company code box 43a13, and an optional flag box 43a14.

In the flag box 43a11, a figure “99”, which indicates that the SRID 43a1 refers to an SRID, is stored. In the member ID box 43a12, a member ID of a member who has completed membership registration is stored. In the company code box 43a13, a company code of a company which has issued a point card is stored. In the optional flag box 43a14, any information may be stored, and, for example, a PTID of a point card issued by the company specified by the company code in the company code box 43a13 is stored.

Similarly, the SRID 43a2 includes a flag box, a member ID box, a company code box, and an optional flag box. The SRID 43an includes a flag box, a member ID box, a company code box, and an optional flag box.

When a new PTID different from the stored PTID is input, the input PTID is overwritten and stored in the corresponding optional flag box 43a14.

Next, a configuration of the portable terminal 7 will be described with reference to a block diagram in FIG. 9. As illustrated in FIG. 9, the portable terminal 7 includes a control unit 71 which generally controls various computations or each unit of the portable terminal 7. The control unit 71 is a computer which includes a CPU, a ROM, a RAM, an RTC unit, and the like. The ROM stores various programs or data. The RAM temporarily stores various programs or stores various data in a rewritable manner. The RTC unit indicates the current date and time.

An operation unit 72 is connected to a display unit 73 through a bus 76. The operation unit 72 has various operation keys or a pointing device for a user (customer) to perform input operations. The display unit 73 is a liquid crystal display, for example. The display unit 73 displays various kinds of information including electronic receipt information. The display unit 73 may have a configuration of a touch panel. In this case, the touch panel functions as the operation unit 72.

The control unit 71 is connected to a communication I/F 74 through the bus 76, and configured to be connected to the network N5 through the communication I/F 74. The control unit 71 may be connected to the network N1 in a store P1 through the communication I/F 74.

The control unit 71 is connected to a storage unit 75 through the bus 76. The storage unit 75 stores an electronic receipt correspondence program 75a for receiving electronic receipt information from the electronic receipt management server 4, and an electronic receipt displaying program 75b for displaying the received electronic receipt information, in addition to a web browser for displaying various kinds of information (contents) which are uploaded to the web.

Next, control processing of each unit which configures the electronic receipt system according to the present embodiment will be described.

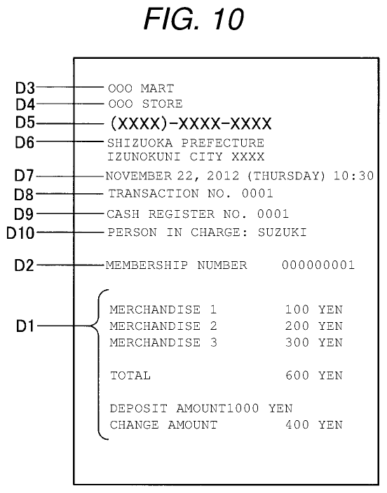

First, electronic receipt processing will be described with reference to FIGS. 10 to 18. The control unit 11 of the POS terminal 1 executes the receipt data processing program 17a, whereby the electronic receipt processing is carried out.

FIG. 10 illustrates an example of receipt data. The receipt data is text data and the like in a non-structured format, and is used in printing by the printing unit 13. As illustrated in FIG. 10, the receipt data includes merchandise sales data D1 and a member ID D2 which are described above. The merchandise sales data D1 includes a merchandise name (merchandise code) of merchandise purchased, and price of each item of the purchased merchandise, a total of the purchased merchandise, a deposit amount paid by a customer, a change amount, and the like.

The receipt data also includes a company code (company name) D3 indicating a company which operates a store, a store code (store name) D4, a telephone number D5, an address D6 of the store, a transaction date and time D7, a transaction number (receipt number) D8, a cash register number D9, a name of a person in charge D10, and the like. The information included in the receipt data are not limited to the example in FIG. 10, and may include other components such as a business type and business category code, or may not include the telephone number D5, the address D6, or the like.

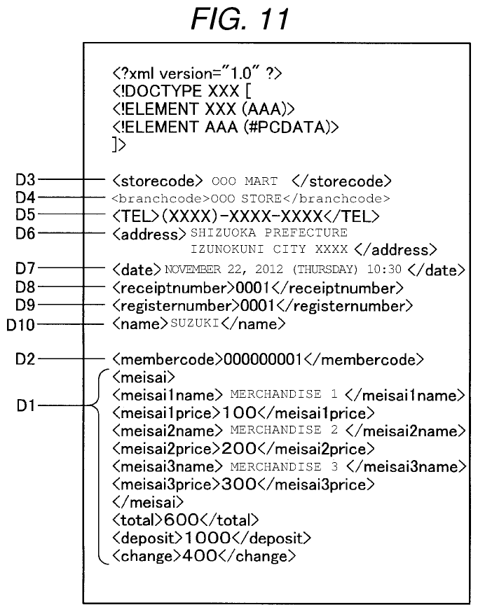

FIG. 11 illustrates an example of electronic receipt information. As illustrated in FIG. 11, the electronic receipt information includes data (structured document) of a structured format such as an XML and a CSV. FIG. 11 illustrates an example in which a format of the information (D1 to D10) in the receipt data illustrated in FIG. 10 is converted to an XML format.

The receipt data is converted into the electronic receipt information based on a conversion rule described in the receipt data schema (not illustrated). Specifically, predetermined information in the receipt data and attribute information (tag and the like) indicating an attribute of the information are defined in the receipt data schema. The control unit 11 generates the electronic receipt information of the structured format as illustrated in FIG. 11 by causing the information of receipt data to be structured using the corresponding attribute information. It is possible to efficiently use the information in the electronic receipt information by generating the electronic receipt information of the structured format in this manner, and thus it is possible to obtain various advantages in data management.

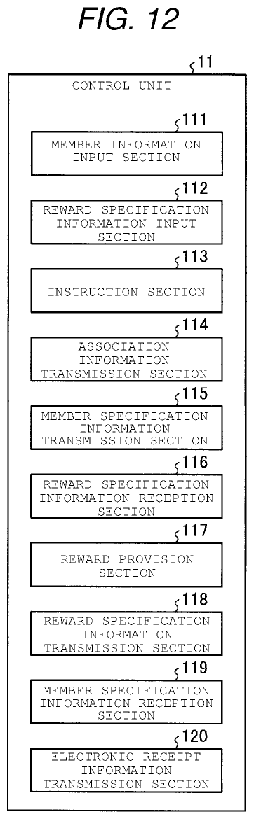

FIG. 12 is a block diagram of functional sections generated when the control unit 11 of the POS terminal 1 executes the receipt data processing program 17a. When the control unit 11 reads the receipt data processing program 17a from the storage unit 17 and executes the receipt data processing program 17a, a member specification information input section 111, a reward specification information input section 112, an instruction section 113, an association information transmission section 114, a member specification information transmission section 115, a reward specification information reception section 116, a reward provision section 117, a reward specification information transmission section 118, a member specification information reception section 119, and an electronic receipt information transmission section 120 are generated.

The member specification information input section 111 has a function to input member specification information (member ID) for specifying a destination of electronic receipt information relating to merchandise sales.

The reward specification information input section 112 has a function to input a reward member ID (PTID) for specifying a destination of a reward relating to merchandise sales.

The instruction section 113 has a function to instruct association of data.

The association information transmission section 114 has a function to transmit an instruction of association, member specification information (member ID), reward member ID (PTID), and company specification information (company code) as a series of data to a server (electronic receipt management server 4) when an instruction from the instruction section 113 is received, in order to generate association information (SRID) which is obtained by associating the member specification information (member ID), the reward member ID (PTID), and the company specification information (company code), with each other.

The member specification information transmission section 115 has a function to transmit the member specification information (member ID) to a company server (store server 2 or headquarter server 3) which stores the association information (SRID) which is generated by the server (electronic receipt management server 4), when the member specification information (member ID) is input by the member specification information input section 111.

The reward specification information reception section 116 has a function to receive the reward member ID (PTID) from the company server (store server 2 or headquarter server 3).

The reward provision section 117 has a function to provide reward to a destination which is specified by the reward member ID (PTID) which is received by the reward specification information reception section 116.

The reward specification information transmission section 118 has a function to transmit a reward member ID (PTID) to the company server (store server 2 or headquarter server 3) which stores the association information (SRID) which is generated by the server (electronic receipt management server 4), when the reward member ID (PTID) is input by the reward specification information input section 112.

The member specification information reception section 119 has a function to receive the member specification information (member ID) from the company server (store server 2 or headquarter server 3).

The electronic receipt information transmission section 120 has a function to generate electronic receipt information corresponding to the member specification information (member ID) which is received by the member specification information reception section 119, and to transmit the generated electronic receipt information.

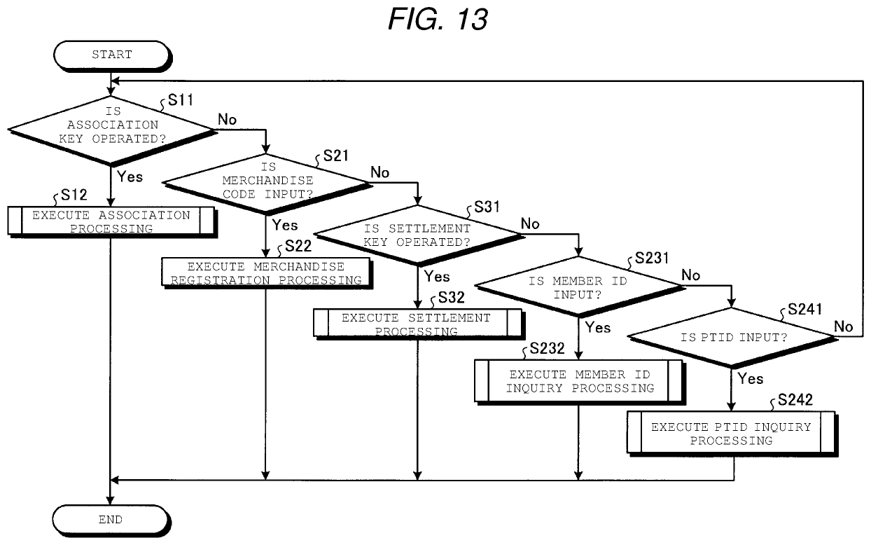

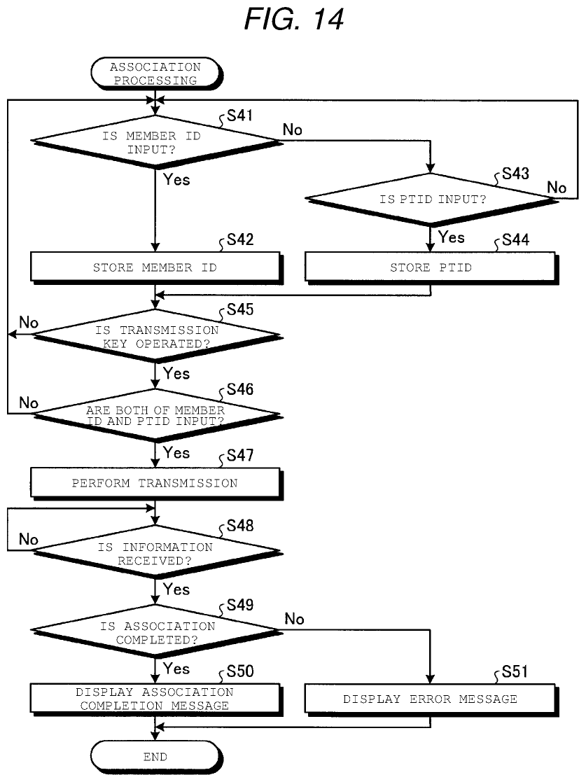

FIG. 13 is a flowchart illustrating a flow of processing carried out by the POS terminal 1. First, the control unit 11 (instruction section 113) of the POS terminal 1 determines whether or not the association key 122 is operated (Step S11). When the association key 122 is determined to be operated (Yes in Step S11), the control unit 11 executes association processing of a member ID and a PTID with each other, which is illustrated in FIG. 14 (Step S12).

When it is determined that the association key 122 is not operated (No in Step S11), the control unit 11 determines whether or not a merchandise code represented by a code symbol attached to merchandise is read and input by the code reader unit 15 (Step S21). When it is determined that the merchandise code is input (Yes in Step S21), the control unit 11 executes merchandise registration processing based on the merchandise code (Step S22).

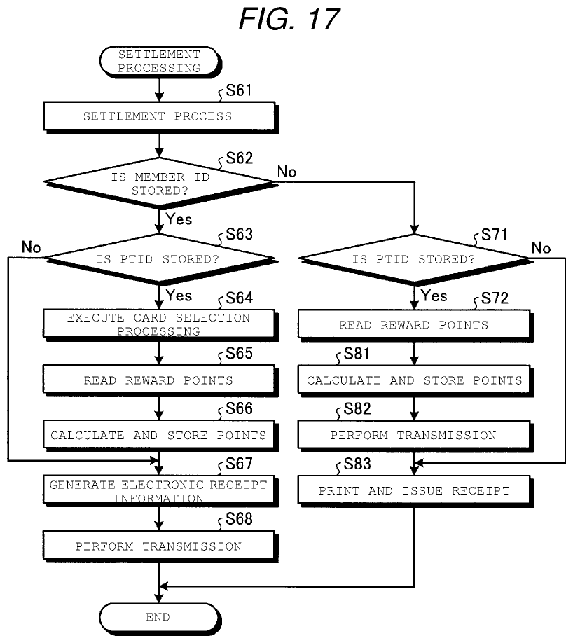

When it is determined that the merchandise code is not input (No in Step S21), the control unit 11 determines whether or not the settlement key 121 is operated (Step S31). When the settlement key 121 is determined to be operated (Yes in Step S31), the control unit 11 executes settlement processing in FIG. 17 (Step S32).

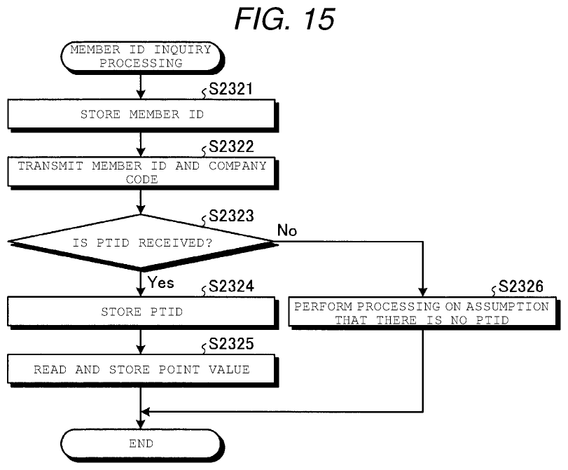

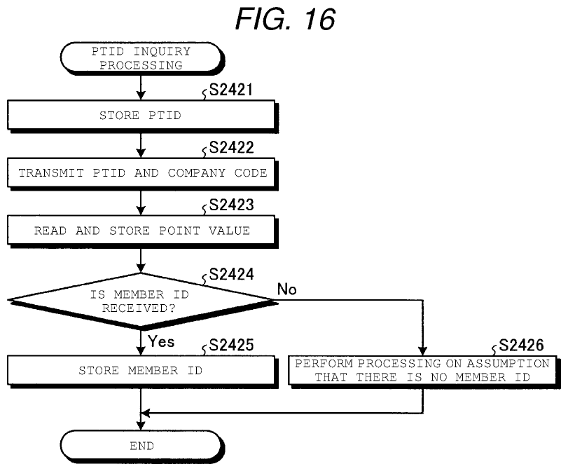

When it is determined that the settlement key 121 is not operated (No in Step S31), the control unit 11 determines whether or not the member ID is input (Step S231). When the member ID is determined to be input (Yes in Step S231), the control unit 11 executes member ID inquiry processing in FIG. 15 (Step S232). When it is determined that the member ID is not input (No in Step S231), the control unit 11 determines whether or not the PTID is input (Step S241). When the PTID is determined to be input (Yes in Step S241), the control unit 11 executes PTID inquiry processing in FIG. 16 (Step S242). When it is determined that the PTID is not input (No in Step S241), the control unit 11 causes the process to return to Step S11.

FIG. 14 is a flowchart specifically illustrating the association processing of Step S12. First, the control unit 11 (member specification information input section 111) determines whether or not the member ID is input (Step S41). In the present embodiment, the member ID is input through the code reader unit 15, when the code reader unit 15 reads a barcode which is displayed on the display unit 73 of the portable terminal 7. When it is determined that the member ID is input (Yes in Step S41), the control unit 11 stores the input member ID in the RAM of the control unit 11 (Step S42).

When it is determined that the member ID is not input (No in Step S41), the control unit 11 (reward specification information input section 112) determines whether or not the PTID is input (Step S43). In the present embodiment, the PTID is input through the code reader unit 15, when the code reader unit 15 reads a barcode printed on a point card held by a member. When it is determined that the PTID is input (Yes in Step S43), the control unit 11 stores the input PTID and a company code of a company which issues the point card of the PTID, in the RAM of the control unit 11 (Step S44).

After the member ID and the PTID are input, a salesperson operates the transmission key 123. The control unit 11 determines whether or not the transmission key 123 is operated (Step S45). When the transmission key 123 is determined to be operated (Yes in Step S45), the control unit 11 determines whether or not both of the member ID and the PTID are stored in the RAM (Step S46).

When it is determined that both of the member ID and the PTID are stored (Yes in Step S46), the control unit 11 (association information transmission section 114) correlates the member ID and the PTID stored in the RAM and the company code stored in the POS terminal 1, and an association command for instructing association of this data as a series of data and transmits a result of correlation to the electronic receipt management server 4 (Step S47). The control unit 11 determines whether or not information relating to association of the member ID and the PTID is received from the electronic receipt management server 4 (Step S48).

The control unit 11 waits for reception of the information relating to association of the member ID and the PTID (No in Step S48). When the information is determined to be received (Yes in Step S48), the control unit 11 determines whether or not association of the member ID and the PTID has been performed at this time (Step S49). When the association is determined to be performed (Yes in Step S49), the control unit 11 causes a message indicating execution of the association to be displayed on the display unit 14 (Step S50). When it is determined that the association is not performed at this time (No in Step S49), the control unit 11 causes a message indicating that the association has not been performed to be displayed along reasons that the association has not been performed (Step S51). Also when the association has been performed previously, the message may be displayed.

When it is determined that the PTID is not input in Step S43 (No in Step S43), when it is determined that the transmission key 123 is not operated in Step S45 (No in Step S45), and when it is determined that neither of the member ID and the PTID are stored in the RAM in Step S46 (No in Step S46), the control unit 11 causes the process to return to Step S41.

Next, member ID inquiry processing executed in Step S232 will be described with reference to FIG. 15. In FIG. 15, the control unit 11 causes the input member ID to be stored (Step S2321). The control unit 11 (member specification information transmission section 115) transmits the stored member ID along with the company code stored in the POS terminal 1 to the store server 2 and inquires a PTID (Step S2322). Then, the control unit 11 (reward specification information reception section 116) determines whether or not a PTID associated with the member ID transmitted from the store server 2 has been received (Step S2323).

When the PTID is determined to have been received (Yes in Step S2323), the control unit 11 causes the received PTID to be stored (Step S2324). The control unit 11 reads and stores a point value of the corresponding customer from the point column 8a3 in the point master 8a stored in the headquarter server 3 based on the stored PTID (Step S2325). Specifically, the control unit 11 reads and stores the point value in correlation with the PTID stored in the point master 8a of the headquarter server 3, based on stored PTID. When it is determined that the PTID has not been received (No in Step S2323), the control unit 11 causes the process to proceed on an assumption that there is no PTID associated with the member ID (Step S2326).

Next, the PTID inquiry processing executed in Step S242 will be described with reference to FIG. 16. In FIG. 16, the control unit 11 causes the input PTID to be stored (Step S2421). The control unit 11 (reward specification information transmission section 118) transmits the stored PTID along with the company code stored in the POS terminal 1 to the store server 2 and inquires a member ID (Step S2422). Then, the control unit 11 reads and stores the point value from the point column 8a3 of the point master 8a stored in the headquarter server 3, based on the stored PTID (Step S2423).

The control unit 11 (member specification information reception section 119) determines whether or not a member ID associated with the PTID transmitted from the store server 2 has been received (Step S2424). When the member ID is determined to have been received (Yes in Step S2424), the control unit 11 causes the received member ID to be stored (Step S2425). When it is determined that the member ID has not been received (No in Step S2424), the control unit 11 causes the process to proceed on an assumption that there is no member ID associated with the PTID (Step S2426).

FIG. 17 is a flowchart specifically illustrating settlement processing carried out by the POS terminal 1 in Step S32. In FIG. 17, the control unit 11 carries out the settlement processing based on merchandise registration information which is obtained through the process of Step S22 (Step S61).

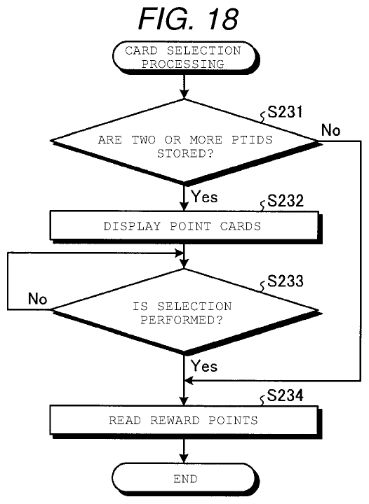

The control unit 11 determines whether or not the member ID is stored in Step S2321 or Step S2425 (Step S62). When it is determined that the member ID is stored (Yes in Step S62), the control unit 11 determines whether or not the PTID is stored in Step S2324 or Step S2421 (Step S63). When the PTID is determined to be stored (Yes in Step S63), the control unit 11 executes card selection processing in FIG. 18 (Step S64).

Then, the control unit 11 reads the point value stored in Step S2325 based on the stored PTID (Step S65). The control unit 11 (reward provision section 117) calculates the total reward points by adding a point earned at this time, which is calculated in a settlement process of Step S61, and causes the total reward points to be stored in the point column 8a3 (Step S66). That is, the control unit 11 causes a reward to be provided to the destination of the reward. The control unit 11 transmits information including the stored reward points to the point master 8a of the headquarter server 3. The control unit 11 generates electronic receipt information based on the merchandise registration information, the settlement information, the points, the member ID, the company code, and the like (Step S67). The control unit 11 (electronic receipt information transmission section 1201) transmits the generated the electronic receipt information to the electronic receipt management server 4 (Step S68).

When it is determined that the member ID is not stored in Step S62 (No in Step S62), the control unit 11 determines whether or not the PTID is stored (Step S71). When the PTID is determined to be stored (Yes in Step S71), the control unit 11 reads the reward points stored through Step S2423 (Step S73).

The control unit 11 calculates the total reward points by adding points earned at this time, which is calculated in the settlement process of Step S61 to the reward points read in Step S72, and causes the updated total reward points to be stored in the point column 8a3 (Step S81). That is, the control unit 11 causes a reward to be provided to the destination of the reward. The control unit 11 transmits information including the stored reward points to the point master 8a of the headquarter server 3 (Step S82). The control unit 11 causes the printing unit 13 to print information based on the settlement process of Step S61, and issues a receipt as illustrated in FIG. 9 (Step S83).

Next, the card selection processing executed in Step S64 of FIG. 17 will be described with reference to FIG. 18. In FIG. 18, the control unit 11 determines whether or not the number of the stored PTIDs is equal to or more than two (Step S231). For example, when the customer presents both of the member ID and the point card which are displayed in the portable terminal 7 during a purchase transaction using the POS terminal 1, the member ID is input to the POS terminal 1, the PTID in association with the input member ID is stored, and the stored PTID does not match the PTID of a point card, the control unit 11 determines that the number of the stored PTIDs is equal to or more than two. When the stored PTID matches the PTID of the point card, the control unit 11 determines that the number of the stored PTIDs is one.

When it is determined that the input PTID does not match the stored PTID, that is, the number of the input PTIDs is equal to or more than two (Yes in Step S231), the control unit 11 causes all point cards which are specified by the input PTID to be displayed on the display 14a for operator and the display 14b for customer (Step S232). The salesperson requests that the customer selects one of the point cards. The customer views the two types or more of point cards which are displayed on the display 14b for customer, and then touches to select a point card.

The control unit 11 determines whether or not one of the point cards is selected (Step S233). The control unit 11 waits for selection, when one of the point cards is determined to be not selected (No in Step S233). When one of the point cards is determined to be selected (Yes in Step S233), the control unit 11 selects the point card selected by the customer, and reads the stored reward points from the point master 8a based on the PTID of the selected point card (Step S234). Then, the control unit 11 executes a process of Step S65 or Step S73. When it is determined that the number of the input PTID is not equal to or more than two (that is, one) (No in Step S231), the control unit 11 reads the reward points stored through Step S2325 or Step S2423 (Step S234).

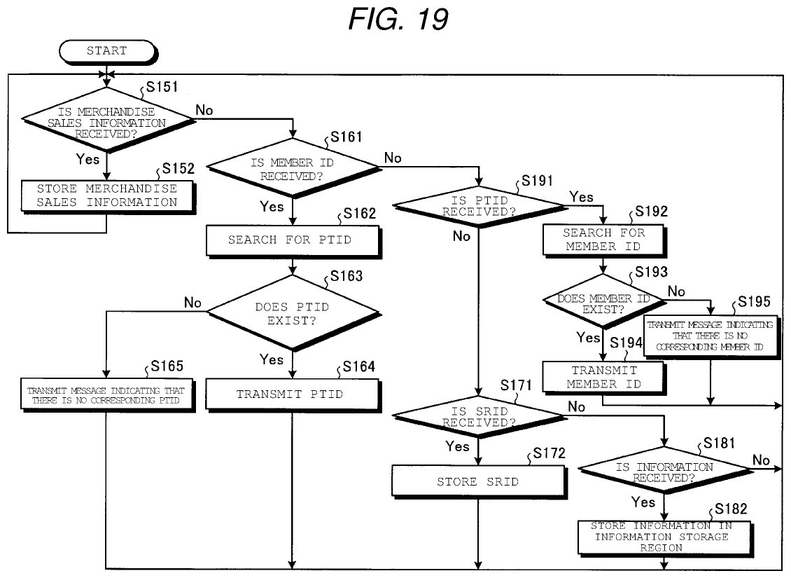

Next, control processing carried out by the control unit 21 of the store server 2 will be described with reference to FIG. 19. In FIG. 19, the control unit 21 determines whether or not merchandise sales information is received from the POS terminal 1 (Step S151). When it is determined that the merchandise sales information is received (Yes in Step S151), the control unit 21 accumulates the received merchandise sales information in the merchandise sales information region 25a and causes the merchandise sales information for the store P1 to be stored (Step S152).

When it is determined that the merchandise sales information is not received from the POS terminal 1 (No in Step S151), the control unit 21 determines whether or not the member ID is received from the POS terminal 1 through the process of Step S2322 (Step S161). When the member ID is determined to be received (Yes in Step S161), the control unit 21 searches for a PTID associated with the member ID, based on information stored in the point region 25b and based on the member ID and the company code which are received (Step S162). The control unit 21 determines whether or not there is the PTID associated with the member ID (Step S163).

When it is determined that there is the PTID associated with the member ID (Yes in Step S163), the control unit 21 transmits the PTID to the POS terminal 1 (Step S164). When it is determined that there is no PTID associated with the member ID (No in Step S163), the control unit 21 transmits an error message indicating that there is no corresponding PTID, to the POS terminal 1 (Step S165).

When it is determined that the member ID is not received (No in Step S161), the control unit 21 determines whether or not the PTID is received through the process of Step S2422 (Step S191). When the PTID is determined to be received (Yes in Step S191), the control unit 21 searches for a member ID associated with the PTID based on information stored in the point region 25b, and based on the member ID and the company code which are received (Step S192). The control unit 21 determines whether or not there is the member ID associated with the PTID (Step S193).

When it is determined that there is the member ID associated with the PTID (Yes in Step S193), the control unit 21 transmits the member ID to the POS terminal 1 (Step S194). When it is determined that there is no member ID associated with the PTID (No in Step S193), the control unit 21 transmits an error message indicating that there is no corresponding member ID, to the POS terminal 1 (Step S195).

When it is determined that the member ID is not received from the POS terminal 1 through the process of Step S64 in Step S191 (No in Step S161), the control unit 21 determines whether or not an SRID obtained by associating the member ID and the PTID with each other is received from the electronic receipt management server 4 through the headquarter server 3 (Step S171). When it is determined that the SRID is received (Yes in Step S171), the control unit 21 causes the received SRID to be stored in the point region 25b (Step S172).

When it is determined that the SRID obtained by associating the member ID and the PTID with each other is not received from the electronic receipt management server 4 through the headquarter server 3 (No in Step S171), the control unit 21 determines whether or not various kinds of information is received from the headquarter server 3 (Step S181). When it is determined that the information is received (Yes in Step S181), the control unit 21 causes the received information to be stored in the information storage region 25c (Step S182). After the process of Step S152, the process of Step S164, the process of Step S165, the process of Step S172, the process of Step S182, and the process of Step S195, the control unit 21 causes the process to return to Step S151. When it is determined that the information is not received in Step S181 (No in Step S181), the control unit 21 causes the process to return to Step S151.

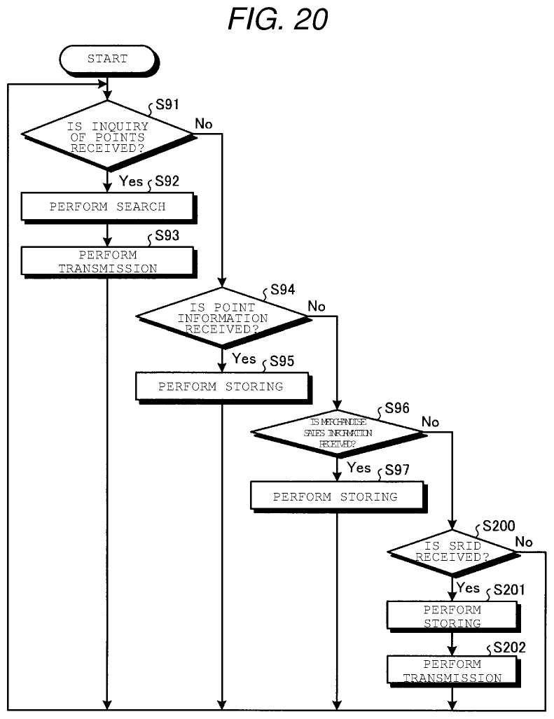

Next, a flow of point management processing will be described with reference to a flowchart illustrated in FIG. 20. The control unit 31 of the headquarter server 3 executes the control program 33c, whereby the point management processing is executed.

The control unit 31 of the headquarter server 3 determines whether or not an inquiry of the reward points is received from the POS terminal 1, designating a PTID (Step S91). When the inquiry is determined to be received (Yes in Step S91), the storage unit 33 searches the point master 8a and reads the reward points stored in the point column 8a3 and corresponds to the PTID (Step S92). Then, the read reward point is transmitted to the POS terminal 1 which has transmitted the inquiry (Step S93).

When it is determined that the inquiry of the reward points is not received from the POS terminal 1 (No in Step S91), the control unit 31 determines whether or not the reward points are received from the POS terminal 1 (Step S94). When it is determined that the reward points are received (Yes in Step S94), the control unit 31 causes the received reward points to be stored in the point column 8a3 in correlation with the PTID received at the same time (Step S95).

When it is determined that the reward points are not received from the POS terminal 1 (No in Step S94), the control unit 31 determines whether or not merchandise sales information of merchandise which is subjected to settlement processing is received from the POS terminal 1 (Step S96). When the merchandise sales information is determined to be received (Yes in Step S96), the control unit 31 causes the received merchandise sales information to be stored in the storage unit 33 (Step S97).

When it is determined that the merchandise sales information is not received from the POS terminal 1 in Step S96 (No in Step S96), the control unit 31 determines whether or not an SRID obtained by associating the member ID and the PTID with each other is received from the electronic receipt management server 4 (Step S200). When it is determined that the SRID is received (Yes in Step S200), the control unit 31 causes the received SRID to be stored in the point master 8a (Step S201). Then, the control unit 31 transmits the stored SRID to the store server 2 (Step S202). The store server 2 stores the received SRID in the point region 25b. The control unit 31 causes the process to return to Step S191. When it is determined that the SRID obtained by associating the member ID and the PTID with each other is not received in Step S200 (No in Step S200), the control unit 31 causes the process to return to Step S91.

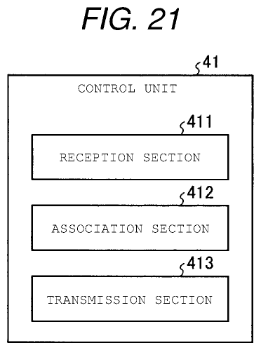

FIG. 21 is a block diagram of functional sections generated when the control unit 41 of the electronic receipt management server 4 executes the electronic receipt management program 43c. The control unit 41 reads and executes the electronic receipt management program 43c from the storage unit 43 and generates the reception section 411, the association section 412, the transmission section 413.

The reception section 411 has a function to receive company specification information (company code) of a company, member specification information (member ID) for specifying a destination of the electronic receipt information, and reward member ID (PTID) for specifying a destination of the reward, from the outside.

The association section 412 has a function to generate the association information (SRID) by associating the company specification information (company code), the member specification information (member ID), and the reward member ID (PTID) which are received by the reception section 411 with each other, and to store the generated association information.

The transmission section 413 has a function to transmit the association information (SRID) to the company server (store server 2 or headquarter server 3) of the corresponding company and is specified by the company specification information (company code).

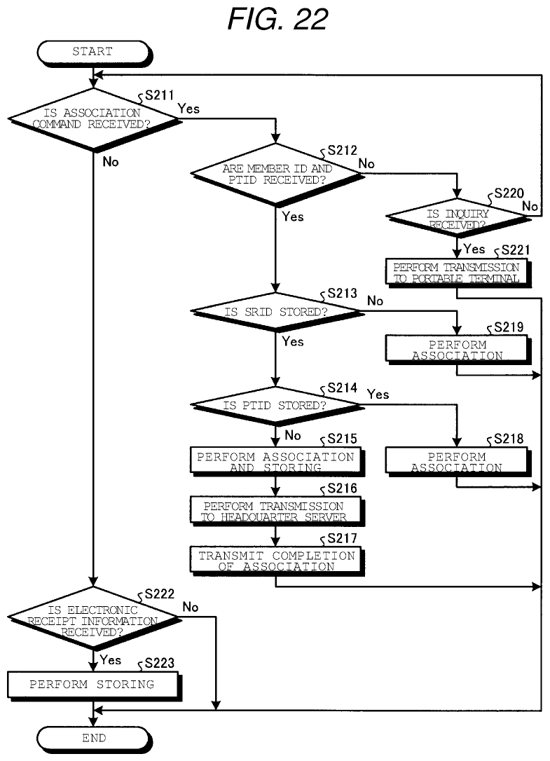

FIG. 22 is a flowchart illustrating control processing carried out by the electronic receipt management server 4. In FIG. 22, the control unit 41 (reception section 411) determines whether or not an association command is received from the POS terminal 1 (Step S211). When the association command is determined to be received (Yes in Step S211), the control unit 41 determines whether or not the member ID, the PTID, and the company code, which are correlated with each other as a series of data, are received along with the association command (Step S212).

When it is determined that the member ID, the PTID, and the company code are received (Yes in Step S212), the control unit 41 determines whether or not an SRID including the received member ID is stored in the electronic receipt management region 43a (Step S213). When it is determined that the SRID is stored (Yes in Step S213), the control unit 41 determines whether or not the PTID associated with the member ID is stored in the corresponding optional flag box 43a14 (Step S214).

When it is determined that the PTID is not stored (No in Step S214), the control unit 41 (association section 412) causes the PTID to be stored in the optional flag box 43a14 of the corresponding SRID and performs association of the member ID and the PTID (Step S215). At the same time, the control unit 41 causes the company code received in Step S212 and associated as a series of data to be stored in the company code box 43a13 of the stored SRID. The control unit 41 associates the member ID, the PTID, and the company code with each other, and causes a result of association to be stored (Step S215).

Then, the control unit 41 (transmission section 413) transmits the SRID including the member ID and the PTID associated therewith through Step S215, to the headquarter server 3 of a company which is specified by the company code stored in the company code box 43a13 (Step S216). The headquarter server 3 which receives the SRID transmits the received SRID to store servers 2 of all stores P1 which are operated by the company. The control unit 41 transmits information indicating that the association of the member ID and the PTID has been completed, to the POS terminal 1 (Step S217).

When it is determined that the PTID has been already stored (Yes in Step S214), the control unit 41 causes the received PTID to be stored in the optional flag box 43an4 of an SRID corresponding to the PTID. The control unit 41 replaces the stored PTID with the new PTID which is received, and causes the new PTID to be stored in the electronic receipt management region 43a (Step S218). As a result, the member ID and the new PTID are associated with each other.

When it is determined that the SRID including the received member ID is not stored in the electronic receipt management region 43a in Step S213 (No in Step S213), the control unit 41 associates the received member ID and the new PTID with each other, and causes a result of the association to be stored in the electronic receipt management region 43a (Step S219).

When it is determined that the member ID, the PTID, and the company code are not received in Step S212 (No in Step S212), the control unit 41 determines whether or not an inquiry of electronic receipt information is received from the portable terminal 7 (Step S220). When it is determined that the inquiry is received (Yes in Step S220), the control unit 41 transmits the electronic receipt information to the portable terminal 7 which has transmitted the inquiry and causes the portable terminal 7 to be in a state where the electronic receipt information is displayable (Step S221). When it is determined that the inquiry of the electronic receipt information is not received from the portable terminal 7 (No in Step S220), the control unit 41 causes the process to return to Step S101.

When it is determined that the association command is not received in Step S211 (No in Step S211), the control unit 41 determines whether or not electronic receipt information is received from the POS terminal 1 (Step S222).

When the electronic receipt information is determined to be received (Yes in Step S222), the control unit 41 causes the received electronic receipt information to be stored in the electronic receipt management region 43a (Step S223).

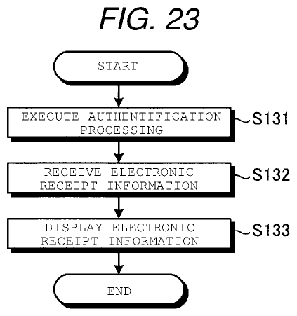

Next, a flow of electronic receipt reception processing and a flow of electronic receipt displaying processing will be described with reference to FIG. 23. The control unit 71 of the portable terminal 7 executes the electronic receipt correspondence program 75a, whereby the electronic receipt reception processing is carried out. The control unit 71 executes the electronic receipt displaying program 75b, whereby the electronic receipt displaying processing is carried out.

As illustrated in FIG. 23, first, the control unit 71 of the portable terminal 7 accesses the electronic receipt management server 4, and executes member authentication processing by inputting a member ID and a password, which are information of a destination (Step S131). As a result, the portable terminal 7 and the predetermined member ID of a customer are correlated with each other.

After the member authentication, the control unit 71 of the portable terminal 7 receives electronic receipt information which is stored and managed in the electronic receipt management region 43a of the electronic receipt management server 4 in association with the input member ID, from the electronic receipt management server 4 (Step S132). When additional information is correlated with the electronic receipt information, the additional information is also received from the electronic receipt management server 4. The electronic receipt information may be received through an electronic mail by using a mail address which is stored in the membership master. Then, the control unit 71 causes the received electronic receipt information and the like to be displayed on the display unit 73 (Step S133), and ends the processing.

According to the present embodiment, since the member ID and the PTID are associated with each other when both are input at the same time, it is possible to associate the member ID and the PTID with each other and to store a result of the association as an initial registration process, for example.

In the present embodiment, the SRID obtained by associating the member ID and the PTID is output to the store server 2 from the electronic receipt management server 4 through the headquarter server 3 based on the input member ID. Thus, for example, when the member ID is input from the portable terminal 7, even though the point card is not presented, it is possible to provide reward points to the PTID corresponding to the member ID. Accordingly, the customer may not need to carry the point card at the time of a purchase transaction.

In the present embodiment, the SRID including the member ID which is associated based on the input PTID is output to the store server 2 from the electronic receipt management server 4 through the headquarter server 3. Thus, if the point card is presented, even though the member ID is not input from the portable terminal 7, it is possible to receive the electronic receipt information by using the SRID which includes the associated member ID. Accordingly, the customer may not need to carry the portable terminal 7 at the time of a purchase transaction.

In the present embodiment, since the SRID obtained by associating the member ID and the PTID is stored in the store server 2, if the member ID input to the POS terminal 1 is received, the PTID associated with the corresponding member ID is transmitted to the POS terminal 1. For this reason, the customer may receive a reward points without the point card.

In the present embodiment, since the member ID and the PTID are associated with each other and stored in the store server 2, if the PTID which is input to the POS terminal 1 is received, the SRID including the associated member ID is searched for so that the electronic receipt information may be displayed on a display unit of the corresponding portable terminal 7. For this reason, the customer may view the electronic receipt information without carrying the portable terminal 7.

According to the present embodiment, when the PTID associated with the input member ID does not match the PTID input by reading the point card, the customer is prompted to select one PTID among the PTIDs and the control unit 11 executes point processing for the selected PTID.

The POS terminal 1 may inquire the PTID or the member ID to the headquarter server 3, not the store server 2. In this case, the control unit 11 of the POS terminal 1 transmits the member ID to the headquarter server 3 and inquires the PTID. The control unit 31 of the headquarter server 3 searches for the PTID associated with the member ID. The control unit 31 transmits the PTID associated with the member ID to the POS terminal 1. The control unit 11 transmits the PTID to the headquarter server 3 and inquires the member ID. The control unit 31 searches for the member ID associated with the PTID. The control unit 31 transmits the member ID associated with the PTID to the POS terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above embodiment, the member ID and the like are input through the code reader unit 15. However, it is not limited thereto, and the member ID and the like may be input using other methods. Specifically, the POS terminal 1 and the portable terminal 7 may include near field wireless communication units such as a near field communication (NFC) and Bluetooth (registered trademark), and the member ID and the like may be transmitted or received using near field wireless communication. In this case, the portable terminal 7 stores the member ID and the like in the storage unit 75, an IC tag (not illustrated), or the like.

In the above embodiment, the PTID for specifying a point card is described as an example. However, a card for providing a reward to a member may not be the point card. In addition, a medium other than a card may be also used.

In the above embodiment, the portable terminal 7 is used as an example of the customer terminal. However, a mounted type personal computer or a tablet terminal may be used.

In the above embodiment, the member ID and the like are input from the portable terminal 7. However, it is not limited thereto, and the member ID and the like may be input from a medium of enabling the member ID to be held, such as an IC card and a magnetic card. When the IC card is used, the POS terminal 1 may include a reading and writing unit such as an IC card reader and writer. When the magnetic card is used, the POS terminal 1 may include a card reader and writer for a magnetic card, and the like.

In the above embodiment, the headquarter server 3 is provided in the headquarter P2. However, it is not limited thereto, and the headquarter server 3 for a store may be provided in the store P1.

What is claimed is:

1. A point-of-sale data processing apparatus, comprising:
a code reader configured to read a product code, an electronic receipt program member code that identifies a user to a first server that stores electronic receipt data for a plurality of users in association with electronic receipt program member codes thereof, and a reward program member code that identifies the user to a second server that stores reward values for a plurality of users in association with reward program member codes thereof;
a communication interface;
an operation panel; and
a processor configured to:
determine whether a code read by the code reader is the product code, the electronic receipt program member code, or the reward program member code,
upon determining that the code read by the code reader is the product code, register the product identified by the product code for purchase by the user,
upon determining that the code read by the code reader is the electronic receipt program member code, communicate through the communication interface with a third server that stores a correspondence between the electronic receipt program member code and the reward program member code for the user to determine the reward program member code and with the second server to determine a reward value associated with the reward program member code,
upon determining that the code read by the code reader is the reward program member code, communicate through the communication interface with the third server to determine the electronic receipt program member code and with the second server to determine the reward value associated with the reward program member code, and
upon settlement being instructed on the operation panel, carry out settlement processing to complete a transaction with the user, the settlement processing including transmitting the electronic receipt program member code and electronic receipt data for one or more registered products through the communication interface to the first server and update the electronic receipt data stored for the user in the first server, calculating an updated reward value based on a sum of the determined reward value and an earned reward value that is earned based on the transaction, and transmitting the reward program member code and the updated reward value for the transaction through the communication interface to the second server such that the rewards data stored for the user in the second server is updated to the updated reward value.

2. The point-of-sale data processing apparatus according to claim 1, wherein
the electronic receipt program member code is read from a mobile computing device carried by the user, and
the reward program member code is read from a medium carried by the user.

3. The point-of-sale data processing apparatus according to claim 1, wherein
upon code association being instructed on the operation panel after the processor determining that a code read by the code reader is the electronic receipt program member code and another code read by the code reader is the reward program member code, the processor transmits to the third server the electronic receipt program member and reward program member codes along with a command to associate the electronic receipt program member code with the reward program member code.

4. The point-of-sale data processing apparatus according to claim 3, wherein
the processor receives a notice from the third server when the third server associates the transmitted electronic receipt program member code with the transmitted reward program member code.

5. The point-of-sale data processing apparatus according to claim 1, further comprising:
a touch panel configured to receive a selection of one reward program member code, when both the electronic receipt program member and reward program member codes are read using the code reader and the read reward program member code is different from the determined reward program member code, wherein
the processor transmits the selected second code to the second server in place of the determined second code.

6. The point-of-sale data processing apparatus according to claim 1, further comprising:
a receipt printer, wherein
during the settlement processing, the processor is further configured to control the receipt printer to print a paper receipt when the code read by the code reader is the reward program member code and the third server returns no first code that identifies the user to the first server, and generate an electronic receipt without printing a paper receipt by the receipt printer when the code read by the code reader is the electronic receipt program member code.
